(19) United States
(12) Patent Application Publication
(10) Pub. No.: US 2006/0009165 A1
(43) Pub. Date: Jan. 12, 2006

(54) High frequency circuit

(75) Inventor: Martin Alles, Obersulm-Willsbach (DE)

Correspondence Address: BIRCH STEWART KOLASCH & BIRCH, PO BOX 747, FALLS CHURCH, VA, 22040-0747, US

(73) Assignee: ATMEL GERMANY GMBH

(21) Appl. No.: 11/176,275

(22) Filed: Jul. 8, 2005

(30) Foreign Application Priority Data
Jul. 9, 2004 (DE) 10 2004 033 268.1

(51) Int. Cl. H04B 1/40; H04M 1/00

(52) U.S. Cl. 455/88; 455/550.1

(57) ABSTRACT

A high frequency circuit includes a receive circuit for receiving a signal from an antenna system. The receive circuit being connected to the antenna system through a diode and a phase shifter.

This nonprovisional application claims priority under 35 U.S.C. § 119(a) on German Patent Application No. 102004033268.1, which was filed in Germany on Jul. 9, 2004, and which is herein incorporated by reference.

### BACKGROUND OF THE INVENTION

1. Field of the Invention

The present invention relates to a high frequency circuit.

2. Description of the Background Art

A conventional high frequency circuit is shown in FIG. 1. The antenna is used both to receive and to transmit signals. For switching between a transmitting operation and a receiving operation, the diodes D₁ and D₂ are provided, which are operated in a forward direction in order to conduct a high-frequency signal and can be operated in a reverse direction in order to attenuate a high-frequency signal.

### SUMMARY OF THE INVENTION

It is an object of the present invention to provide a high frequency circuit that increases reliability in transmitting operation to the greatest degree possible.

Accordingly, a high frequency circuit is equipped with a receive circuit to receive a signal from an antenna system. In this arrangement, the receive circuit is connected to the antenna system through a diode and a phase shifter. According to the invention, a receive signal passes from the antenna system through the diode and the phase shifter to the receive circuit. In this context, the connection encompasses the first variant, where the receive circuit is connected to the antenna system exclusively through a single diode and a single phase shifter, and also every other variant, in which the connection between the receive circuit and the antenna system is made through the diode, the phase shifter, and one or more additional components such as capacitors, resistors or semiconductors.

Various diode types can be used for the diode. Preferably, the characteristics of the diode for high-frequency signals can be controlled through a voltage applied to the diode, particularly a reverse voltage, or through a diode current, particularly in the forward direction. A receive circuit is, for example, a receiving amplifier, which can potentially also have an impedance matching device. An antenna system has at least one antenna. In addition, the antenna system can have other components, for example, such as a capacitor or semiconductor, which preferably are integrated into the antenna system.

In an embodiment of the invention, the phase shifter is designed such that it effects a substantially total reflection of a transmit signal present at the antenna. The total reflection has the effect that the transmit signal entering the phase shifter is almost totally reflected, so only very low residual power passes through the phase shifter. The phase shifter preferably has a quarter-wave section for this purpose.

In an embodiment of the invention, the diode is connected on the receive circuit side and/or the phase shifter is connected on the antenna system side. For a connection on the receive circuit side, the diode can be connected to the receive circuit through a capacitor or an impedance matching device, for example. Thus, the diode can be directly connected to the receive circuit and/or the phase shifter can be directly connected to the antenna system.

According to a further embodiment of the invention, the diode can be switched by a switching current in the forward direction for transmission of the signal from the antenna system to the receive circuit, and can preferably be switched by a reverse voltage in the reverse direction for attenuating signals to the receive circuit. This measure makes it possible, for example, to switch between a transmit operation and a receive operation, since the signals from the antenna system to the receive circuit can be attenuated. If the diode does not carry a current in the forward direction, but instead is unpowered or is connected to a voltage in the reverse direction, a space charge region forms which effects an attenuation of high-frequency transmit signals. Naturally, a pure DC voltage is not strictly necessary for this switch function. Thus, any current in the forward direction that has a requisite DC component for the function and, for example, is superposed on an alternating current, can be used for this switch function.

The high frequency circuit preferably has a short-circuiting device that is connected to the quarter-wave section and is designed such that a short circuit of high-frequency signals (HF signals) can be switched to ground or to a supply voltage connection. This short-circuiting device can be a single component, for example a high-frequency switching transistor, or of multiple components, for example an additional diode with a capacitor. Any connection to any DC and/or AC voltage which makes possible a short-circuit for the HF signals and is available for this function can be used as the supply voltage connection. The high-frequency signals are, for example, interfering signals or high-power transmit signals from a power amplifier. In this context, the short-circuiting device preferably is a first additional diode, which effects the short circuit by a switching current in the forward direction. Also, the diode and a first additional diode can be designed as a dual diode.

A second additional diode can be provided through which a transmit circuit is connected to the antenna system. While it is possible in principle to provide a direct connection between the power transmit amplifier and the antenna system solely through the second additional diode, it is nonetheless preferred for the connection to be made through the second additional diode and additional components such as a capacitor or an impedance matching device.

An embodiment of this further development of the invention provides that, for a transmit operation, the second additional diode can be switched by a switching current in the forward direction for transmission of a transmit signal from the transmit circuit to the antenna system. Accordingly, it is possible to disconnect the transmit circuit from the antenna system in receive mode, so that the input impedance of the receive circuit, in particular, can be designed independently of the output impedance of the transmit circuit.

The first additional diode and the second additional diode can be wired such that, in a transmit operation, current in the forward direction can be applied to both the first additional diode and the second additional diode. This simultaneously effects a slight attenuation of the transmit signal from the transmit amplifier to the antenna system and a high attenuation of the signal from the transmit amplifier to the receive circuit. Preferably, the currents flowing through the first additional diode and the second additional diode are connected through a single switch output of a transmit/receive component so that only one output pin needs to be used for this dual function.

The receive circuit and/or the transmit circuit can be designed for a transmission frequency of 2.4 GHz. This transmission frequency of 2.4 GHz permits the use of this high frequency circuit in newer cordless telephones, in particular those using the new DECT standard. For this reason, the inventive high frequency circuit is used in particular in a mobile transmit/receive device (DECT standard) for the transmission of data, especially voice data. In addition to voice data, it is of course also possible to transmit image data or other information, for instance Internet data from a computer system.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 illustrates a high frequency circuit according to the conventional art; and

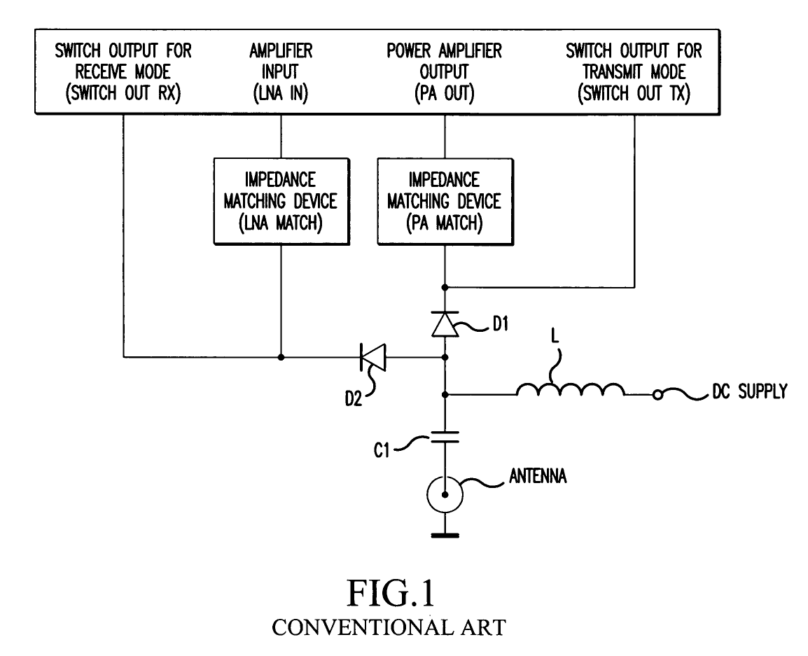

FIG. 2 illustrates a high frequency circuit for transmitting and receiving through a single antenna, according to an embodiment of the present invention.

### DETAILED DESCRIPTION

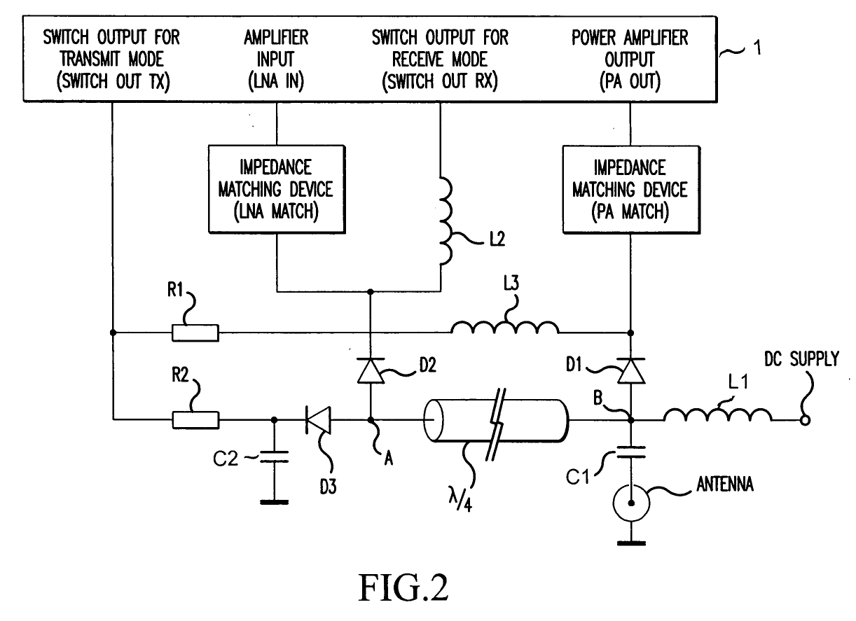

In FIG. 2, a high frequency circuit is shown that makes it possible to transmit and receive by means of a single antenna (antenna). A transmit/receive component 1 has an output Paout of a high frequency power amplifier for transmit operation, which output is connected to the antenna through an impedance matching device Pamatch, a diode D₁, and a capacitor C₁.

In addition, the input LNAin of a high frequency receive amplifier with low inherent noise of the transmit/receive component 1 is connected to the antenna through an impedance matching device LNAmatch of the high frequency receive amplifier, a diode D₂, a phase shifter—which in this case has a quarter-wave section λ/4, and through the capacitor C₁.

Two additional outputs SWITCHoutTX and SWITCHoutRX of the transmit/receive component 1 serve to control the high frequency connections of the transmit/receive component 1. For transmit operation, the output SWITCHoutTX is switched to a low voltage, while the output SWITCHoutRX is switched to a high voltage. Conversely, for receive operation the output SWITCHoutRX is switched to a low voltage, while the output SWITCHoutTX is switched to a high voltage.

The goal here is for the transmit signals from the output PAout of the high frequency power amplifier to arrive at the antenna through the switching node B with the minimum possible attenuation in a transmit operation. In contrast, the transmit signals that reach the input LNAin of the high frequency receive amplifier through the switching nodes B and A should be attenuated to the maximum degree possible, in order not to destroy the high frequency receive amplifier. To this end, multiple components with the function of switchable impedances for high frequency signals are provided in FIG. 2.

A receive operation will be examined in detail first. In the receive operation, a DC current flows through the diode D₂ in the forward direction. To this end, the switch output SWITCHoutRX is switched to a lower voltage as a supply voltage DCsupply. This causes a flow of current from the supply voltage connection DCsupply through the inductance L₁, the quarter-wave section λ/4, the diode D₂ and the inductance L₂, into the switch output SWITCHoutRX. Due to the polarity of the diode D₂ in the forward direction, the receive signals received by the antenna can also reach the input LNAin of the transmit/receive component 1 through the diode D₂, since for high-frequency signals the diode D₂ causes only negligible attenuation of the receive signal. The attenuation of the quarter-wave section λ/4 and the impedance matching device LNAmatch is likewise negligible for the method of operation.

So that additional components exert a merely negligible effect on the overall input impedance in receive operation, they are decoupled from the receive connection. The receive connection in this arrangement is present between the antenna and the input LNAin of the receive amplifier. The inductance L₂ is provided to decouple the switch output SWITCHoutRX. The inductance L₁ is provided to decouple the supply voltage connection DCsupply. Additional decoupling for the high frequency receive signals is accomplished by the diodes D₁ and D₃. In this regard, the diodes D₁ and D₃ are not operated in the forward direction. To this end, the voltage at the output SWITCHoutTX is equal to or greater than the supply voltage DCsupply. The space charge regions which thus arise in the diodes D₁ and D₃ in the receive operation produce a high impedance for the frequency of the receive signal, so that only a high frequency receive signal current that is negligibly small for the overall impedance flows through the diodes D₁ and D₃.

A transmit operation is considered in detail below. In the transmit operation, a DC current flows through the diodes D₁ and D₃ in the forward direction. To this end, the voltage at the switch output SWITCHoutTX for transmit mode is lower than the supply voltage DCsupply by at least the diode drop for the diodes D₁ and D₃. This in turn results in a DC current from the supply voltage connection DCsupply through the inductance L₁, the diode D₁, the inductance L₃, and the resistance R₁ to the switch output SWITCHoutTX for the transmit mode. In addition, another DC current from the supply voltage connection DCsupply through the inductance L₁, the quarter-wave section λ/4, the diode D₃, and the resistance R₂ to the switch output SWITCHoutTX is produced for the transmit mode.

Since the DC current flows through the diode D₁ in the forward direction, the diode D₁ does not represent a significant attenuating element for the transmit signal. The transmit signal thus passes nearly unattenuated from the output PAout of the high frequency power amplifier of the transmit/receive component 1 to the antenna.

The high frequency circuit shown in FIG. 2 has the advantage that, in transmit mode, the transmit signal passing from the output PAout of the high frequency power amplifier of the transmit/receive component 1 to the input LNAin of the high frequency receive amplifier of the transmit/receive component 1 is attenuated such that the high frequency receive amplifier is not destroyed by the residual power of the attenuated transmit signal.

This attenuation of the transmit signal is accomplished through two different attenuation principles. The first attenuation is accomplished by the quarter-wave section λ/4 arranged between the switching nodes A and B, and the capacitor C₂ with the diode D₃. Since, as already mentioned, a DC current flows through the diode D₃ in the forward direction in transmit operation, the switching node A is shorted to ground for the high-frequency transmit signals by the diode D₃ and the capacitor C₂. This short circuit for the high-frequency transmit signals, together with the quarter-wave section λ/4, causes an essentially total reflection of the transmit signal, so that the residual power of the totally reflected transmit signal at the switching node A is already very low. The second attenuation is accomplished through the diode D₂, which does not pass a DC current in the forward direction and consequently has a space charge region which further attenuates the residual power of the transmit signal.

However, the invention is not limited to the embodiment shown in FIG. 2. Thus, for example, other variations of embodiments of the invention have a high frequency switching transistor in place of at least one of the diodes D₁ and D₃. It is also possible, for example, to integrate the capacitor C₁ into the antenna as an alternative to the embodiment in FIG. 2, or to omit the capacitor for certain antenna types. Moreover, integration of the impedance matching device LNAmatch into the transmit/receive component 1 is possible, or it is even possible to omit this device if impedance matching is needed at all.

The high frequency circuit in FIG. 2 is preferably designed for wireless transmission with a transmission frequency of 2.4 GHz. This transmission frequency of 2.4 GHz permits the use of this high frequency circuit from FIG. 2 in newer cordless telephones using the new DECT standard. The high frequency circuit from FIG. 2 is used in a mobile or stationary transmit/receive device for the transmission of data, for example voice data. In addition to voice data, it is of course also possible to transmit image data or other information, for instance from a computer system. By means of the specific arrangement within the high frequency circuit of the diode D₂ and the quarter-wave section λ/4, the high frequency circuit from FIG. 2 permits a significant increase in the transmit power without damaging the receive circuit (LNA). An increased transmit power makes it possible to increase the transmitted data rate or the transmit and receive ranges of the system.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

1. A high frequency circuit comprising:
a receive circuit for receiving a signal from an antenna system;
a first diode; and
a phase shifter,
wherein the receive circuit is connected to the antenna system through the first diode and the phase shifter.

2. The high frequency circuit according to claim 1, wherein the phase shifter substantially effects a total reflection of a transmit signal present at the antenna system.

3. The high frequency circuit according to claim 1, wherein the phase shifter has a quarter-wave section.

4. The high frequency circuit according to claim 1, wherein the first diode is connected on a receive circuit side and/or the phase shifter is connected on an antenna system side.

5. The high frequency circuit according to claim 1, wherein the first diode can be switched by a switching current in the forward direction for transmission of the signal from the antenna system to the receive circuit, and wherein the first diode can be switched by a reverse voltage in the reverse direction for attenuating signals to the receive circuit.

6. The high frequency circuit according claim 1, wherein a short-circuit device is connected to the phase shifter such that a short circuit of HF signals can be switched to ground or to a supply voltage connection.

7. The high frequency circuit according to claim 6, wherein the short-circuit device includes a second diode that effects the short circuit by a switching current in the forward direction.

8. The high frequency circuit according to claim 7, wherein the first diode and the second diode are a dual diode.

9. The high frequency circuit according to claim 1, further comprising a third diode for connecting a transmit circuit to the antenna system.

10. The high frequency circuit according to claim 9, wherein, for a transmit operation, the third diode is switched by a switching current in the forward direction for transmission of a transmit signal from the transmit circuit to the antenna system.

11. The high frequency circuit according to claim 9, wherein the second diode and the third diode are connected so that, in the transmit operation, current in the forward direction can be applied to both the second diode and the third diode.

12. The high frequency circuit according to claim 9, wherein the receive circuit and/or the transmit circuit have a transmission frequency of 2.4 GHz.

13. The high frequency circuit according to claim 1, wherein the high frequency circuit is provided in a transmit/receive device and/or a mobile transmit/receive device for the transmission of data.

14. The high frequency circuit according to claim 1, wherein the signal is a high frequency signal.

15. The high frequency circuit according to claim 1, wherein the antenna system includes an antenna and a capacitor.

16. The high frequency circuit according to claim 13, wherein the data is voice data.
